(19) United States
(12) Patent Application Publication
(10) Pub. No.: US 2023/0182023 A1
(43) Pub. Date: Jun. 15, 2023

(54) SOCIAL RECOMMENDATION, DISTRIBUTION, AND DISPLAY OF VIDEO GAME-RELATED PRODUCTS

(71) Applicants: Josiah Eatedali, Los Angeles, CA (US); Robert Schonfeld, Sherman Oaks, CA (US); Garrett Austin Brodie, Los Angeles, CA (US)

(72) Inventors: Josiah Eatedali, Los Angeles, CA (US); Robert Schonfeld, Sherman Oaks, CA (US); Garrett Austin Brodie, Los Angeles, CA (US)

(21) Appl. No.: 17/814,200

(22) Filed: Jul. 21, 2022

Related U.S. Application Data
(63) Continuation of application No. 16/672,274, filed on Nov. 1, 2019, now abandoned.
(60) Provisional application No. 62/769,485, filed on Nov. 19, 2018.

(51) Int. Cl. A63F 13/79; A63F 13/537

(52) U.S. Cl. CPC A63F 13/79; A63F 13/537

(57) ABSTRACT

A recommendation cart may be displayed for a game player, and the recommendation cart may include recommendations from others regarding video game related products. The recommendations may be from friends of the game player in some embodiments, and may include text, audio, or video. In some embodiments the video game related products are video games.

### CROSS REFERENCE TO RELATED APPLICATION

This application claims the benefit of the filing date of U.S. Provisional Patent Application No. 62/769,485, filed on Nov. 19, 2018, the disclosure of which is incorporated by reference herein.

### BACKGROUND OF THE INVENTION

The present invention relates generally to video games, and more particularly to presentation of options for video game procurement based on known party recommendations.

Video games provide fun and enjoyment for many. Video games allow users to participate in a variety of simulated activities. Video games allow users to perform roles and experience activities that the users may not be able or desire to experience directly, whether due to cost, danger, or equipment concerns, or simply due to a role or activity being a fantasy.

In some cases, playing of video games can be a solitary experience, with for example a single game player playing a video game, on their own. In other cases video game play may include multiple players, but the multiple players may not know one another, and may not particularly care or have an interest in when other players achieve accomplishments in the video game, particularly when not then engaged in video game play with or against those players. This possible lack of engagement with other game players may detract from video game play.

Game players may also tend towards playing a particular game, perhaps repeatedly, and perhaps to the exclusion of other games, other games which may broaden experiences of the game player. The other games may be ones that the game player would also enjoy, if only the game player knew of such games. In some cases the game player may merely not know of the opportunities presented by other games, even though other game players may have such knowledge. In some cases the game player may also have difficulty in learning of such games, or finding an opportunity to obtain such games at a time of interest, given the cornucopia of available video games.

### BRIEF SUMMARY OF THE INVENTION

Some embodiments provide a social recommendation cart for video game related goods. In some embodiments the social recommendation cart is presented in a user interface of a game device associated with a game player. In some embodiments the social recommendation cart presents video game related goods which have been recommended by other parties, for example other individuals who have been identified as friends of the game player. In some embodiments the social recommendation cart presents information or provides a means to obtain information as to why a particular video game related good was recommended and/or why the particular video game related good was particularly recommended to the game player.

Some embodiments provide a method for providing particularized recommendations for video game related good, comprising: receiving an indication of a selection of a video game related good by a first user; receiving information regarding the video game related good from a compute device associated with the first user; receiving an indication of identity of at least one second user to whom an identification of the video game related good and the information regarding the video game related good should be provided; and transmitting, to a game device associated with a second user, an indication of the selection of the video game related good and the information regarding the video game related good to the at least one second user. In some embodiments the video game related good is a video game. In some embodiments the information regarding the video game related good is text information. In some embodiments the information regarding the video game related good is audio information. In some embodiments the information regarding the video game related good is video information. In some embodiments the at least one second user is a second user. In some embodiments the indication of identity of the second user is a user ID for the second user. In some embodiments the method further comprises receiving an indication that the second user has obtained ability to use the video game related good for use in video game play. In some embodiments the video game related good is a video game, and the method further comprises receiving an indication that the second user has obtained ability to play the video game on the game device associated with the second user. In some embodiments the method further comprises transmitting, in response to receipt of the indication that the second user has obtained the ability to play the video game on the game device associated with the second user, a notification to the compute device associated with the first user that the second user has obtained the ability to play the video game on the game device associated with the second user.

These and other aspects of the invention are more fully comprehended upon review of this disclosure.

### BRIEF DESCRIPTION OF THE FIGURES

FIG. 1 diagrammatically illustrates display of a user interface for a shopping cart for a game player, including recommendations by parties known to the game player, in accordance with aspects of the invention.

FIG. 2 illustrates a networked video game system in accordance with aspects of the invention.

FIG. 3 is a flow diagram of a process for obtaining, distributing, and acting on recommendations for video game related products, in accordance with aspects of the invention.

FIG. 4 diagrammatically illustrates a user interface for providing recommendations for video game related products, in accordance with aspects of the invention.

FIG. 5 is a flow diagram of a process for distributing recommendations for video game related products, in accordance with aspects of the invention.

### DETAILED DESCRIPTION

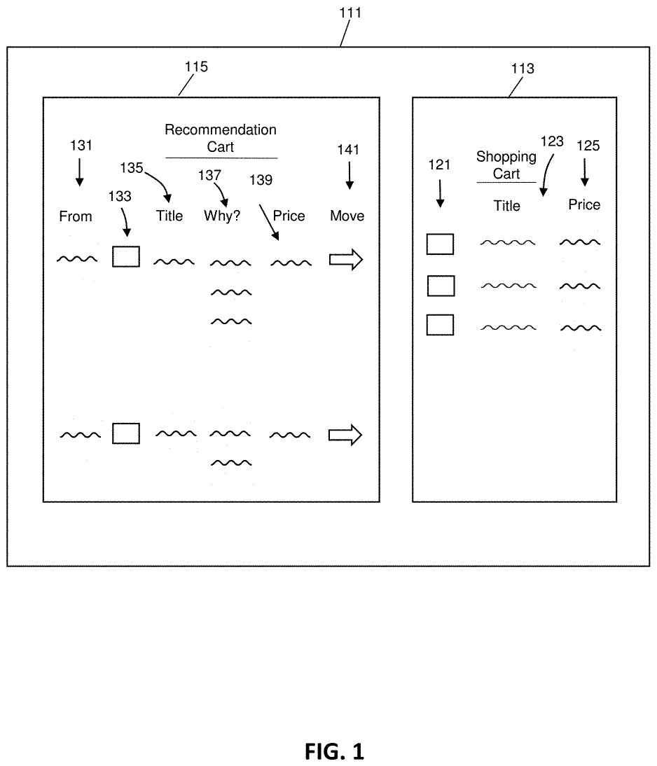

FIG. 1 diagrammatically illustrates a display of a user interface for a shopping cart for a game player, including recommendations by parties known to the game player, in accordance with aspects of the invention. The display of the user interface may be displayed, for example, on a display screen 111 of a game device. The game device is generally configured for play of video games. The game device may be, in various embodiments a game console with associated display device, a personal computer or laptop computer, a tablet computer device, or a smartphone. In general, the game device includes one or more processors, a display device, and user input devices, either as part of the game device or coupled to the game device.

The display of the user interface includes a shopping cart 113. The shopping cart includes items a game player has selected for purchase. The items may have been selected for purchase by the game player by way of a web-based store, of which the shopping cart may be part. In the example of the user interface of FIG. 1, the shopping cart includes icons 121 reflecting items the game player has selected for purchase, along with their titles 123 and prices 125. In various embodiments the game player may have selected the items for purchase from a web-based store, which in some embodiments may be accessed through a web storefront. In various embodiments information of the web-based store, and processing of orders through the web-based store, may for example be provided by a server. The server may be associated with a retailer, a video game publisher, or associated with a producer of a particular game console. In various embodiments the items in the shopping cart may presented in other manners, and may include additional and/or different information, and in some embodiments less information.

The display of the user interface also includes a recommendation cart 115. The recommendation cart includes items that are recommended to the user, for the user to consider purchasing. The items in the recommendations cart each include an identifier 131 of who provided the recommendation, an icon 133 representative of a recommended item, a title 135 of the recommended item, information 137 regarding the recommended item provided by the recommender, and prices 139 of the recommended items.

In some embodiments the recommendations are provided by friends of the game player. In some embodiments the friends are personal friends of the user. In some embodiments the friends are individuals with whom the game player may play video games. In some embodiments the friends are friends of the game player on a social network service or application. In some embodiments the friends are one, some, or all of these.

In some embodiments the friends making the recommendations identify one or more game players to which a recommendation should be provided. In some embodiments the recommendations are provided to game players who are pre-identified as friends of the recommender. In some embodiments the game player determines friends from whom the game player will accept recommendations.

In some embodiments the information regarding the recommended item includes text provided the recommender. In some embodiments the information regarding the recommended item is a link to audio or video content generated by the recommender. In some embodiments the information regarding the recommended item includes an invitation to join a game play session of the recommended item with the recommender.

In some embodiments, and as illustrated in FIG. 1, the display of the user interface additionally includes, for each recommended item, buttons 141 for moving recommended items from the recommendation cart to the shopping cart. In some embodiments a flag is stored in association with the item indicating that the item has been moved from the recommendation cart to the shopping cart. In some embodiments an identifier for the recommendation, and/or the recommender, is also stored in association with the item. In some embodiments one, some, or all of the flag, identifier for the recommendation, and/or the recommender is provided to the server along with an order for the video game related product moved to the shopping cart.

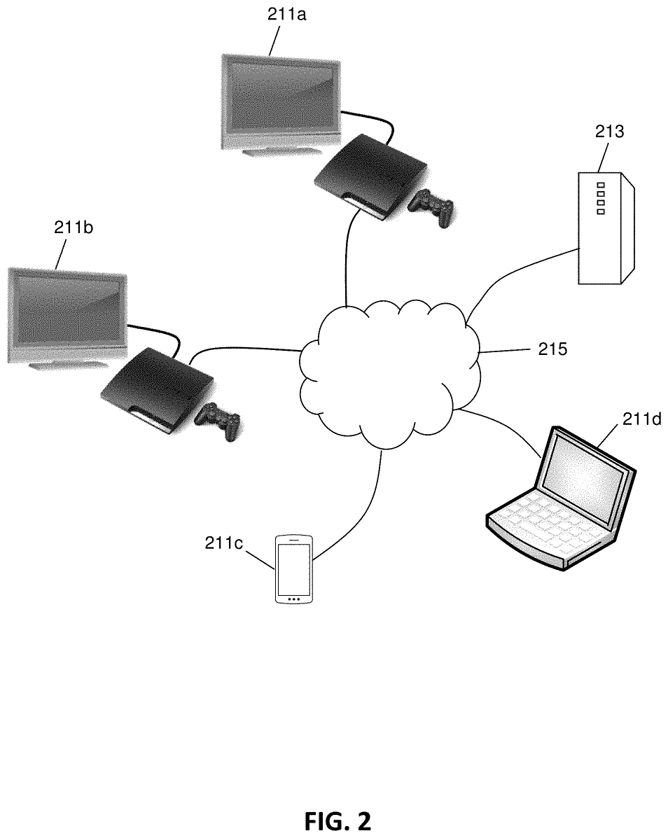

FIG. 2 is a semi-block diagram of a system in accordance with aspects of the invention. The system includes a plurality of game devices 211a-d coupled to each other and a game server 213 over a network 215, which may be for example the Internet. The game devices, and the server, may be considered compute devices. In some embodiments the game server may be a plurality of servers, for example with one of the servers providing information to game devices regarding the web-based store and user interface display of FIG. 1, and in some embodiments links to other servers for functions relating to the actual playing of video games. In some such embodiments the server providing the information regarding the dashboard may also receive information relating to the actual play of video games from the other servers, as well as possibly the game devices.

The game devices 211a and 211b are shown as including a game console having at least one processor, a game controller, and a display. The game device 211c is shown as a smartphone, including at least one processor, a display device, and a touchscreen. The game device 211d is shown as a personal computer, of the laptop type in FIG. 2. More generally, in various embodiments the game devices may instead or in addition comprise a personal computer, a tablet computer, a smart phone, and/or some other compute device, each configured for video game play. In addition, for purposes of illustration, only a small number of game devices are shown in FIG. 2, in most embodiments the number of game devices may be over a thousand, and may be an order of magnitude or orders of magnitude greater than that. In some embodiments, however, the game devices may only consist of game consoles.

The game devices are configured, or configurable, for play of a video game, for example a single player and/or multi-player video game. During play of the video game, a game player utilizes the game controller or other input devices of a game device to control actions of a game character associated with the game player. The game character, responsive to commands provided by the game controller, is in and interacts with a virtual world and its other inhabitants, some of whom may be game characters controlled by other game players and some of whom may be game characters controlled by the video game itself. In some embodiments the game devices are configured to provide information regarding whether game play is occurring, and/or status of game play, to the game server. In some embodiments, for example in multi-player video games, the game server may receive information regarding game play status from the game devices, with the game server distributing the game play status to the various game devices. In some embodiments the game server may instead receive requests for game character actions from the game devices, with the game server determining game play status and distributing information regarding game play status to the game devices.

In some embodiments the game devices are also configured to display a user interface including a recommendation cart, for example the user interface or recommendation cart of FIG. 1, on display devices of the game devices. In such embodiments the game devices may receive information, with which to populate the recommendation cart with recommendations, from the server. In some embodiments the game devices may also be configured to generate information for recommendations, for example based on recommenders operating user input devices of the game devices, and to provide the information for recommendations to the server for distribution to other game devices.

In some embodiments some of the game devices 211a-d may not be game devices, but instead simply be compute devices not configured for game play. For example, in some embodiments the smartphone 211c, or alternatively the laptop 211d, may include social networking applications, audio or video authoring capabilities, and networked communication capabilities, but not be configured for game play.

In some embodiments the recommendations may be generated on a compute device not configured for game play, and provided to the server for distribution to game devices, and/or compute devices in some embodiments. In this vein, in some embodiments the recommendation cart may also be displayed on a compute device not configured for game play, but in communication with the server. For example, in some embodiments a game player may have a smartphone or laptop not configured for game play, with game play instead for example occurring on a game console, but the smartphone or laptop may be configured to display the recommendation cart.

In some embodiments the server receives recommendation information from game devices, and compute devices not configured for game play in some embodiments, and distributes the recommendation information to other game devices, and/or compute devices not configured for game play in some embodiments. In some embodiments the server distributes recommendations based on information provided by game device or compute devices from which the recommendation information is received. For example, in some embodiments the game device providing the recommendation information also provides identities of game players to whom the recommendations should be provided. In some embodiments the server distributes recommendations based on information provided by game devices or compute devices to which the recommendation information is to be provided. For example, in some embodiments game players may cause their game devices or compute devices to provide information to the server as to identities of recommenders from whom the game device or computer device may receive recommendations. In some embodiments the server distributes recommendations based on both information provided by game device or compute devices from which the recommendation information is received and on information provided by game devices or compute devices to which the recommendation information is to be provided.

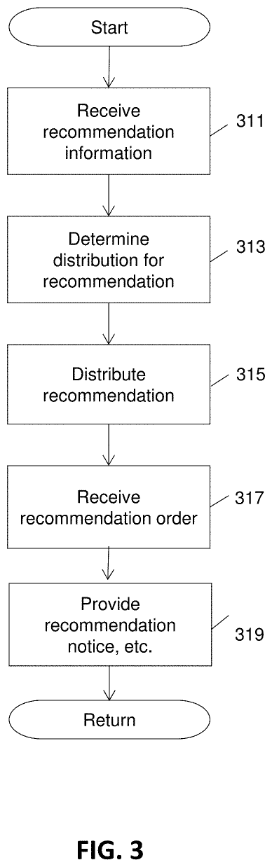

FIG. 3 is a flow diagram of a process for obtaining, distributing, and acting on recommendations for video game related products, in accordance with aspects of the invention. In some embodiments the process is performed by a system, such as the system of FIG. 2. In some embodiments the process, or part of the process, is performed by a server, for example the game server of FIG. 2. In some embodiments the process is performed by one or more processors, for example configured by program instructions.

In block 311 the process receives recommendation information. In some embodiments the recommendation information identifies a video game related product, and includes information regarding the video game related product. In some embodiments the video game related product is a video game. In some embodiments the video game related product is a virtual item, for example virtual equipment, virtual apparel, or other virtual item for use by or with a virtual character in a video game. In some embodiments the recommendation information is received by a server, for example the server of FIG. 2. In some embodiments the recommendation information is provided to the server by a compute device. In some embodiments the compute device is a game device. In some embodiments the recommendation information identifies of one or more game players to be recipients of the recommendation information. In some embodiments the recommendation information identifies the one or more game players by a game player ID. In some embodiments the recommendation information regarding the video game related product is text, entered into the compute device by a recommender operating the compute device from which the recommendation information is provided. In some embodiments the recommendation information is audio and/or video information recorded by the compute device, and the audio and/or video information may be a presentation by the recommender.

In block 313 the process determines a distribution for the recommendation. In some embodiments the process determines compute devices to which the recommendation should be transmitted. In some embodiments the process determines game devices to which the recommendation should be transmitted. In some embodiments the process determines game players to whom the recommendation should be distributed. In some embodiments the process determines that the recommendation should be transmitted to the one or more game players (or compute or game devices associated with game players) identified in the recommendation information. In some embodiments the process determines that the recommendation should be distributed to game players identified as friends of the recommender on a social network application. In some embodiments the process determines that the recommendation should be distributed to game players who are, or have been in some embodiments, teammates of the recommender in video game play. In some embodiments the process determines that the recommendation should be distributed to game players who have requested recommendations from the recommender. In some embodiments the process limits distribution of the recommendation to only those game players who have agreed to accept recommendations from the recommender.

In block 315 the process distributes the recommendation. In some embodiments the server transmits the recommendation over a network, for example the Internet, to compute devices. In some embodiments the server transmits the recommendation over the network to game devices. In some embodiments the process distributes the recommendation to those determined to receive the recommendation in block 313.

In optional block 317, the process receives an order for the video game related product from a game player who received the recommendation. In some embodiments the order includes a flag indicating that the video game related product was moved from a recommendation cart to a shopping cart. In some embodiments the order includes an identification of a recommendation distributed for the video game related product. In some embodiments the order includes an identification of a recommender of the video game related product.

In optional block 319 the process provides a notification to the recommender of the order for the video game related product recommended by the recommender. In some embodiments the process provides a credit or reward to the recommender. In some embodiments the reward may be a virtual item for use in a video game by a virtual character controlled by the recommender.

The process thereafter returns.

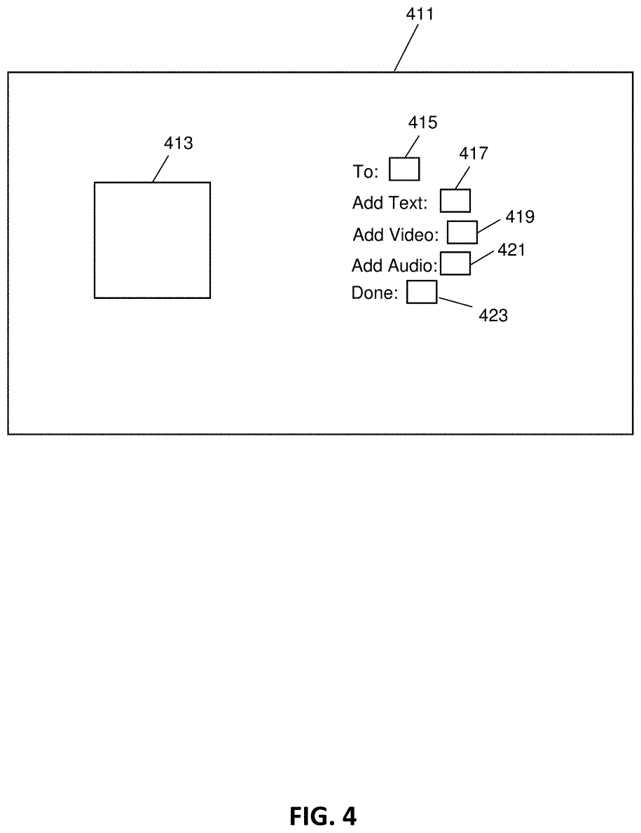

FIG. 4 diagrammatically illustrates a user interface for providing recommendations for video game related products, in accordance with aspects of the invention. The display of the user interface may be displayed, for example, on a display screen 411 of a game device. In some embodiments the display of the user interface may be displayed on a display screen of a compute device not configured for game play.

The user interface includes an icon 413 representative of a video game related product. In some embodiments the video game related product may have been selected on a web-based store, for example by a user, operating a compute device, who wants to provide a recommendation. The user interface also includes a plurality of selectable icons. The selectable icons include a To selectable icon 415 for indicating to whom the recommendation should be sent, an Add Text selectable icon 417 for use in providing text for the recommendation, an Add Video selectable icon 419 for use in providing video for the recommendation, an Add Audio selectable icon 421 for use in providing audio for the recommendation, and a Done selectable icon for use in indicating that the recommendation is complete. In various embodiments, however, selectable icons for different purposes may be provided, and in various embodiments a different user interface for providing recommendations may be provided.

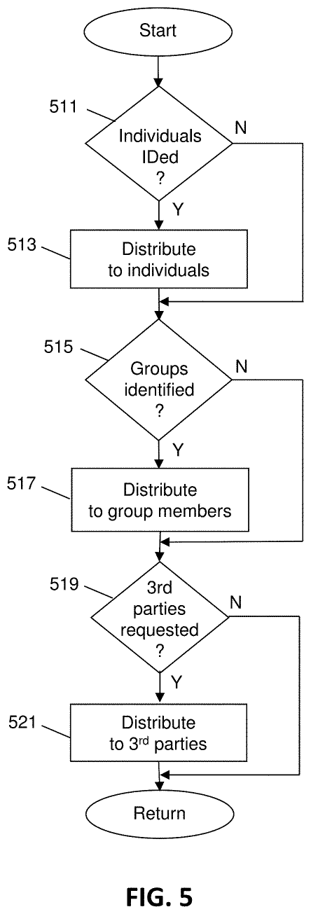

FIG. 5 is a flow diagram of a process for distributing recommendations for video game related products, in accordance with aspects of the invention. In some embodiments the process is performed by a system, such as the system of FIG. 2. In some embodiments the process, or part of the process, is performed by a server, for example the game server of FIG. 2. In some embodiments the process of FIG. 5 performs operations of block 313 and 315 of the process of FIG. 3. In some embodiments the process is performed by one or more processors, for example configured by program instructions.

In block 511 the process determines if individual game players are identified in recommendation information of a recommendation as being intended recipients of the recommendation. In some embodiments the individual game players are identified by game player IDs. In some embodiments the individual game players are identified by other identification criteria, for example by email addresses. In some embodiments the process further determines if the identified game players have consented to receive recommendations from a recommender providing the recommendation. If the process determines that individual game players are identified in the recommendation information, the process continues to block 513. Otherwise the process goes to block 515.

In block 513 the process distributes the recommendation, including the recommendation information, to the individual game players identified in the recommendation information. In some embodiments the process transmits the recommendation information to compute devices associated with the individual game players. In some embodiments the process waits to transmit the recommendation information until a request is made by compute devices associated with the individual game players, for example a request for a web-based store for information or a request to display a shopping cart page for a predetermined web-based store. In some embodiments the process does not distribute the recommendations to compute devices associated with game players who have not consented to receiving recommendations from the recommender.

In block 515 the process determines if one or more groups of game players are identified in recommendation information of a recommendation as being intended recipients of the recommendation. In some embodiments the groups may comprise or consist of friends on a social network application of the recommender. In some embodiments the process further determines if the game players of the group have consented to receive recommendations from a recommender providing the recommendation. If the process determines that one or more groups are identified in the recommendation information, the process continues to block 517. Otherwise the process goes to block 519.

In block 517 the process distributes the recommendation, including the recommendation information, to the individual game players who are members of the group(s) identified in the recommendation information. In some embodiments the process queries a social networking application to obtain information of the individuals of the group(s). As with the operations of block 513, in some embodiments the process transmits the recommendation information to compute devices associated with the individual game players. Also as with the operations of block 513, in some embodiments the process waits to transmit the recommendation information until a request is made by compute devices associated with the individual game players, for example a request for a web-based store for information or a request to display a shopping cart page for a predetermined web-based store. In some embodiments the process does not distribute the recommendations to compute devices associated with game players who have not consented to receiving recommendations from the recommender.

In block 519 the process determines if individual game players have requested to receive recommendations from the recommender. If so, the process continues to block 521, otherwise the process returns.

In block 521 the process distributes the recommendation, including the recommendation information, to the individual game players who have requested to receive recommendations from the recommender. As discussed with respect to prior blocks, in some embodiments transmits the recommendation information to compute devices associated with the individual game players, while in some embodiments the process waits for receipt of a predetermined request from a compute device associated with a game player prior to transmitting the recommendation information.

The process thereafter returns.

Although the invention has been discussed with respect to various embodiments, it should be recognized that the invention comprises the novel and non-obvious claims supported by this disclosure.

1. A method for providing particularized recommendations for video game related good, comprising:
receiving an indication of a selection of a video game related good by a first user;
receiving information regarding the video game related good from a compute device associated with the first user;
receiving an indication of identity of at least one second user to whom an identification of the video game related good and the information regarding the video game related good should be provided; and
transmitting, to a game device associated with a second user, an indication of the selection of the video game related good and the information regarding the video game related good to the at least one second user.

2. The method of claim 1, wherein the video game related good is a video game.

3. The method of claim 1, wherein the information regarding the video game related good is text information.

4. The method of claim 1, wherein the information regarding the video game related good is audio information.

5. The method of claim 1, wherein the information regarding the video game related good is video information.

6. The method of claim 1, wherein the at least one second user comprises a second user.

7. The method of claim 6, wherein the indication of identity of the second user is a user ID for the second user.

8. The method of claim 1, further comprising receiving an indication that the second user has obtained ability to use the video game related good for use in video game play.

9. The method of claim 1, wherein the video game related good is a video game, and further comprising receiving an indication that the second user has obtained ability to play the video game on the game device associated with the second user.

10. The method of claim 9, further comprising transmitting, in response to receipt of the indication that the second user has obtained the ability to play the video game on the game device associated with the second user, a notification to the compute device associated with the first user that the second user has obtained the ability to play the video game on the game device associated with the second user.
